(19) United States
(12) Patent Application Publication
(10) Pub. No.: US 2012/0266508 A1
(43) Pub. Date: Oct. 25, 2012

(54) LADDER RACK SIGN SYSTEM

(76) Inventor: Matt Halper, Southhampton, PA (US)

(21) Appl. No.: 13/274,279

(22) Filed: Oct. 14, 2011

Related U.S. Application Data
(60) Provisional application No. 61/393,028, filed on Oct. 14, 2010.

(51) Int. Cl. G09F 21/04; G09F 15/00

(52) U.S. Cl. 40/591; 40/611.01

(57) ABSTRACT

A ladder rack sign system to be secured to a vehicle or a ladder rack mounted to the vehicle to hide the ladder rack/ladders and to display signs that can be utilized as advertising. The system includes upper and lower tracks to secure one or more signs therewithin, a back plate to support the upper and lower tracks and to space them a certain distance apart, end plates to secure the one or more signs therewithin, and mounting brackets to secure the system to the ladder rack and/or vehicle. The system may be installed on any type of vehicle, any type of ladder racks, roof racks, cargo racks, bike racks or the like. The system, using different mounting brackets or no mounting brackets at all, may be attached to any solid surface (e.g., wall, frame, structure). The system provides easy changing of signs to utilize different advertizing opportunities.

### PRIORITY

This application claims the priority under 35 USC §119 of Provisional Application 61/393,028 entitled “Ladder rack Sign System” filed on Oct. 14, 2010. Application 61/393,028 is herein incorporated by reference in its entirety but is not prior art.

### BACKGROUND

Advertising is often necessary for businesses to get new work. Advertising comes in many forms including the yellow pages (e.g., phone book, Internet versions), a business website (including search optimization), banner ads and/or links on other related websites, television and/or radio commercials, signs and billboards. Advertising is often expensive and does not provide the desired results. Often the advertisement is not immediately associated with work the business has performed in the past or is currently performing. This may be, for example, because the advertisement is not in close proximity to the work where an association may have a more direct impact (e.g., a yellow pages listing may not provide an association to a person who sees work being performed on a neighbor's house).

Vehicles used in the construction and home maintenance/repair businesses often include ladder racks for holding ladders to the top of the vehicle. The view of a ladder rack and associated ladder(s) does not provide an appealing visual.

What is needed is a means to provide a more appealing visual of the ladder rack/ladders and provide an advertising opportunity that may provide a more direct association to work being performed, the location of the business, or associated businesses.

### BRIEF DESCRIPTION OF THE DRAWINGS

The features and advantages of the various embodiments will become apparent from the following detailed description in which:

FIG. 1 illustrates a front view of an example ladder rack sign system, according to one embodiment;

FIG. 2 illustrates a back view of an example ladder rack sign system, according to one embodiment;

FIG. 3 illustrates a top view of an example ladder rack sign system, according to one embodiment;

FIG. 4 illustrates a front view of an example ladder rack sign system with an end plate being taken off to enable a sign to be removed or replaced, according to one embodiment;

FIG. 5 illustrates a perspective front view of an example ladder rack sign system with an end plate being taken off to enable a sign to be removed or replaced, according to one embodiment;

FIG. 6 illustrates a close up perspective view of a side of an example ladder rack sign system after an end plate has been removed, according to one embodiment;

FIG. 7 illustrates a cross-sectional view of an example ladder rack sign system, according to one embodiment; and

FIG. 8 illustrates a close-up cross-sectional view of one of the tracks of an example ladder rack sign system, according to one embodiment.

### DETAILED DESCRIPTION

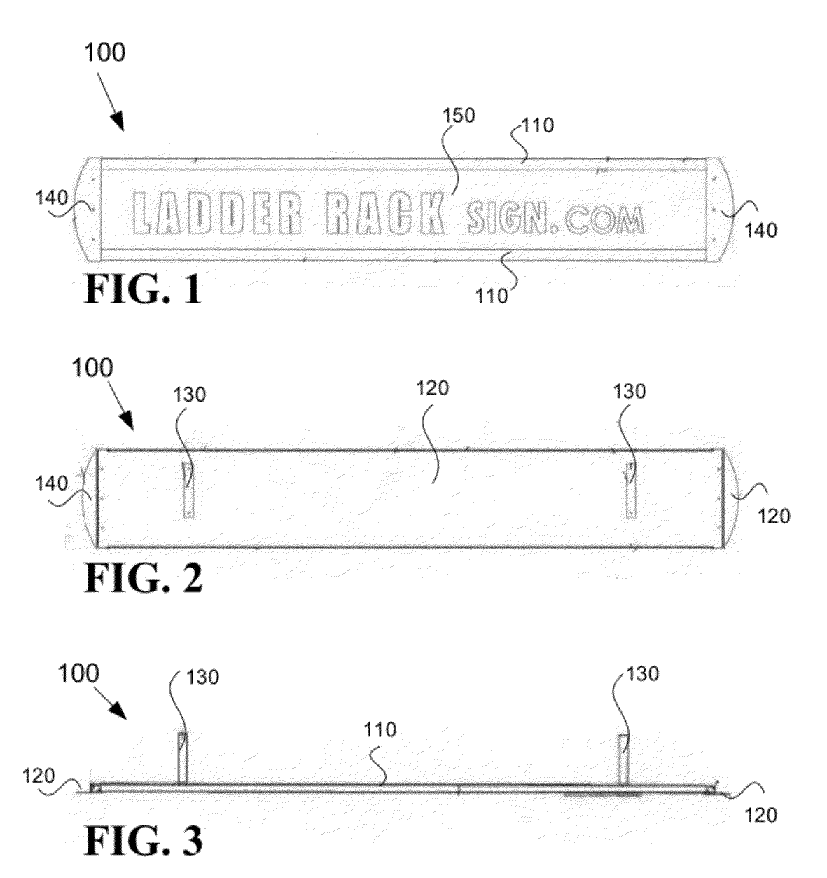

FIGS. 1-8 illustrate various view of an example ladder rack sign system (hereinafter simply referred to as system) 100 designed to hide the ladder rack/ladders and to display signs that can be utilized as advertising. The system 100 may be designed to secure to the ladder rack that is secured to the vehicle so that the system 100 need not mount to the vehicle. The system 100 may include upper and lower tracks 110, a back plate 120, mounting brackets 130, end plates 140, and sign(s) 150.

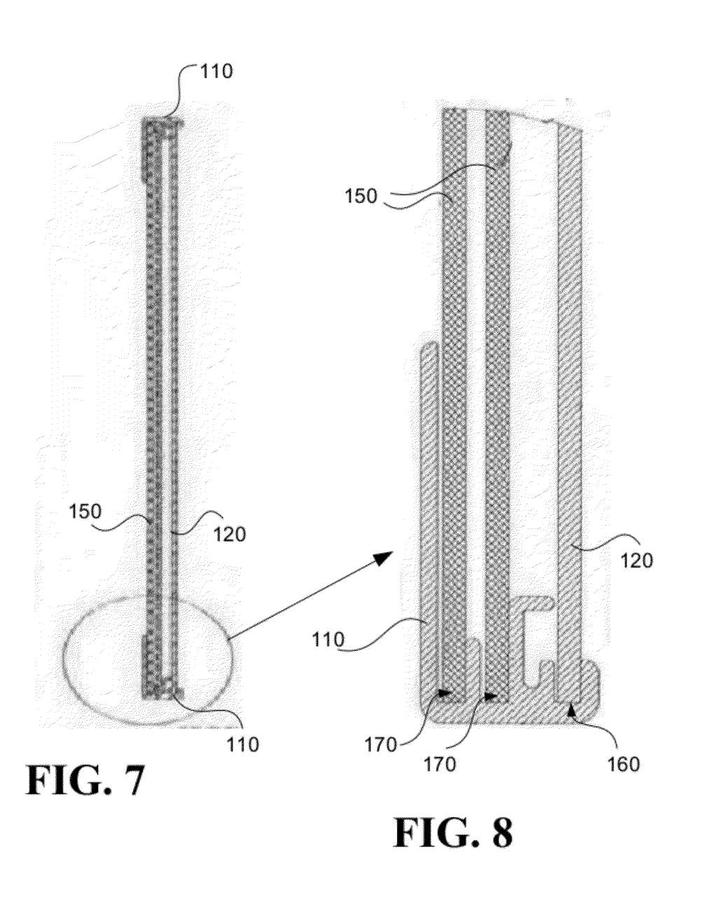

The back plate 120 may be used to support the upper and lower tracks 110 and to space them a certain distance apart. FIGS. 7 and 8 are cross sectional views of the system 100 that illustrate the back plate 120 as a separate piece that is secured within a grove 160 formed in the upper and lower tracks 110. Such a configuration enables back plates 120 of varying heights to be utilized. This provides the ability to adjust the height of the system 100 based on, for example, the ladder rack it may be connected as well as adjust the size of the signs 150 that may be utilized therein. The back plate 120 may be connected to the tracks 110 in various manners including screws, bolts, rivets, clamps, adhesive, welding, crimping or any other temporary securing means (temporary as in can be removed with damaging or destroying the system). If screws, bolts, rivets, or clamps are utilized they and any associated nuts may be made from stainless steel so they do not rust.

The back plate 120 may be made of aluminum (e.g., flat and extruded). Alternatively, the back plate 120 may be made of steel, plastic, wood or any other material capable of supporting the system to a ladder rack, handling the conditions associated with a moving vehicle, and handling various weather conditions (e.g., rain) without compromising the integrity thereof. According to one embodiment, the back plate 120 may be integrated with the upper and lower tracks 110 as a single piece or multiple pieces securely affixed to one another to act as a single piece (e.g., welding).

The back plate 120 is illustrated as a solid piece but is not limited thereto. Rather, the back plate 120 could be any of various types of grids that may provide the necessary support and spacing and be lighter weight.

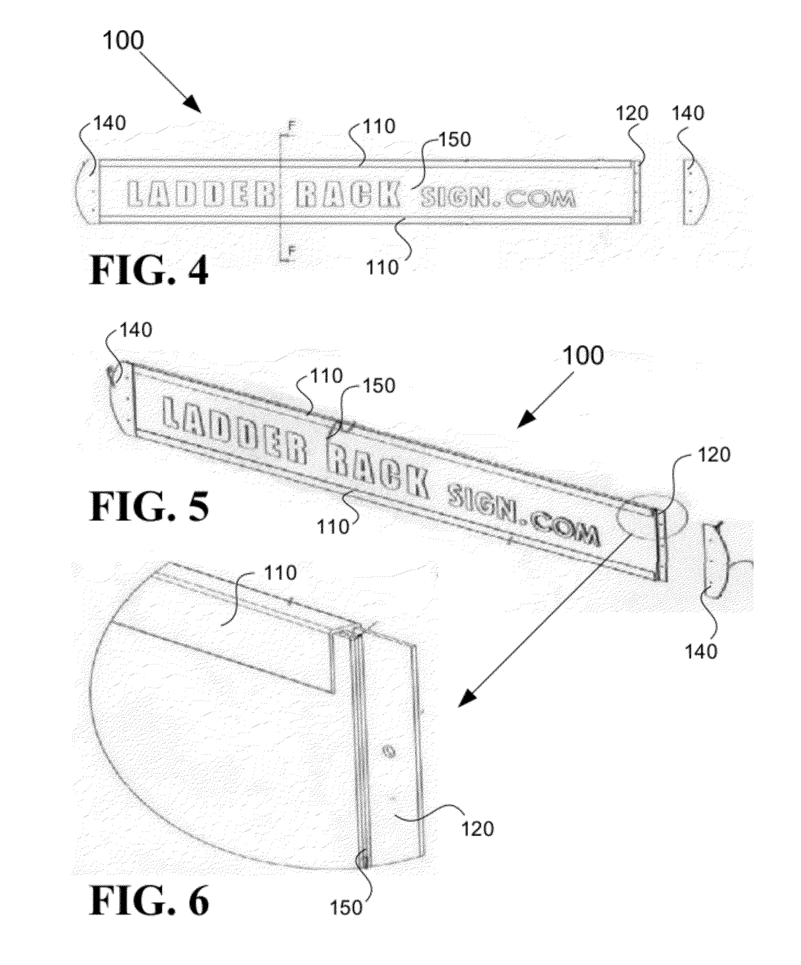

FIGS. 4-6 are perspective views of the system 100 with an end plate 140 removed and illustrate the back plate 120 may extend further then the tracks 110. The extended back plate 120 may enable the end plates 140 to be secured thereto and hold the sign(s) 150 therewithin.

The cross sectional views of FIGS. 7 and 8 illustrate that the tracks 110 may have one or more channels 170 formed therein to support the sign(s) 150 and allow the sign(s) 150 to be slide in and out of the system 100 and secure the signs 150 thereto. Allowing the signs 150 to be removed offers the opportunity for double sided signs 150 to be used so that the advertisement may be changed by sliding the sign 150 out turning it over and sliding it back in. Allowing the signs 150 to be removed also offers the opportunity to replace the current sign 150 with a new sign 150. The tracks 110 may include multiple slots channels 170 for signs 150 to be placed within. Use of multiple channels 170 allows additional signs 150 to be stored within the system 100. Having additional signs 150 stored within the system may allow the operator of the vehicle to changes signs whenever needed (e.g., a contractor may display a sign appropriate for the work they are performing that day).

The upper and lower tracks 110 may be symmetrical so that a single style of track 110 may be used for both the top and bottom of the system and may be used on both sides of a vehicle. The tracks 110 may be made of aluminum (e.g., flat and extruded). Alternatively, the tracks 110 may be made of steel, plastic, wood or any other material capable of supporting the signs 150 therewithin, handling the conditions associated with a moving vehicle, and handling various weather conditions without compromising the integrity thereof. The tracks 110 are illustrated as having a specific profile and including two channels to hold signs 150 and a channel to hold the back plate 120 but is in no way intended to be limited thereto. Rather any number of channels may be utilized and any profile capable of supporting the signs 150 in the system while the vehicle is moving is within the current scope.

The signs 150 may be made of an aluminum clad resin core and vinyl exterior. Alternatively, the signs 150 may be made of wood, plastic or other materials or combination of materials (e.g., wood core and vinyl exterior) capable of withstanding being on a moving vehicle and capable of withstanding the elements (e.g., sun, rain) without fading or compromising the integrity thereof. The images/designs (or portions thereof) on the signs 150 may be florescent/glow in the dark so that it reflects light shined thereon or is visible at night. The florescent/glow in the dark effect may be produced by the material used or the image imprinted thereon. As previously noted the signs 150 may include images/designs (e.g., advertisements) on both sides.

The end plates 140 may be secured to the back plate 120 in a fashion that will cap the ends of the tracks 110 to secure the signs 150 within the system. As illustrated, the end plates 140 may be connected to a portion of the back plate 120 that extends further then the tracks 110. When connected, the front of the end plates 140 may be flush with the outer edge of the tracks 110. As illustrated, the front of the end plates 140 includes a rounded outer edge to provide an aesthetic look to the system. The end plates 140 are not limited to the illustrated embodiments. Rather, any configuration that secures the signs 150 within the system is within the current scope. For example, the end plates 140 may extend over the back plate 120 and the extended portion of the end plates 140 may be connected to the back plate 120.

The end plates 140 may be symmetrical so that a single style of end plate 140 may be used for both the front and back of the system and may be used on both sides of a vehicle. The end plates 140 may be made of aluminum (e.g., flat and extruded). Alternatively, the end plates 140 may be made of steel, plastic, wood or any other material capable of securing the signs 150 within the tracks 110, handling the conditions associated with a moving vehicle, and handling various weather conditions without compromising the integrity thereof.

The end plates 140 may be connected to the back plate 120 using bolts and nuts (the end plates 140 and the back plate 120 may have aligned holes). The bolts and nuts may be made from stainless steel so they do not rust. Alternatively, the end plates 140 may be connected to the back plate 120 in various manners including screws, rivets, clamps, or any other temporary securing means (temporary as in can be removed with damaging or destroying the system). If screws, rivets, or clamps are utilized they and any associated nuts may be made from stainless steel so they do not rust. The end plates 140 may overlap the tracks 110 and/or may be connected to the tracks 110 in some fashion to provide additional support. In order to prevent unauthorized individuals from getting access to the signs 150, the end plates 140 and the back plate 120 may be locked in some fashion (e.g., one of the nuts may be a locking nut that requires a special tool to remove)

The back view of FIG. 2 and the top view of FIG. 3 illustrate the mounting brackets 130 that may be used to connect the system to the ladder rack on the vehicle. The type of mounting brackets 130 utilized may depend on the size and type of ladder rack utilized. The mounting brackets 130 utilized need to securely hold the system to the ladder rack (the connection means needs to be secure and the material utilized needs to withstand the conditions associated with a moving vehicle, weather conditions, and ladders being taken on and off the ladder rack). The mounting brackets 130 need to be capable of being disengaged from the ladder rack so that the system can be removed if desired. The action required to remove the brackets 130 needs to be such that general use (e.g., moving vehicle, weather, use of ladder rack) cannot disengage. The mounting brackets 130 may be made from stainless steel to provide the required strength and so they do not rust.

The mounting brackets 130 may be secured to the back plate 120 using, for example, bolts and nuts (the mounting brackets 130 and the back plate 120 may have aligned holes). The bolts and nuts may be made from stainless steel. The back plate 120 may have various sets of holes formed therein to provide flexibility as to how many mounting brackets 130 are used and where they are connected to. Alternatively, the mounting brackets 130 may be welded to the back plate 120 or may be connected to the back plate 120 in any other secure means. As illustrated, two mounting brackets 130 are utilized but the number is in no way intended to be limited thereby. According to one embodiment, the back plate 120 may be directly connected to the ladder rack using, for example, bolts and nuts (the ladder rack and the back plate 120 may have aligned holes) so that the mounting brackets 130 are not required.

The system 100 was illustrated and described as having upper and lower tracks 110 and front and back end plates 140 such that the signs 150 are inserted into (and removed from) the front or back of the system. According to one embodiment, the system may include front and back tracks 110 and top and bottom end plates 140 such that the signs 150 are inserted into (and removed from) the top or bottom of the system 100.

According to one embodiment, the system 100 may include lights that may be activated, for example, at night. The lights may be powered by a battery that may be included in the system or may be wired to receive power from the vehicle. The lights may be activated by a light sensor or may be activated by a switch. The switch may be included in the system 100, may be in the vehicle and wired to the system (lights), or may be a wireless switch that can be activated with a remote control. The lights may accentuate the sign (e.g., LEDs around the border), shine light onto the sign (e.g., have lights extending from the system that are pointed at the signs 150) or if the signs 150 were made from a translucent material the lights could shine through the signs 150 from within the system 100.

The system 100 may be installed on any type of vehicle that includes a ladder rack. The system 100 may be utilized on any type of ladder rack, including but not limited to, ladder racks that are mounted on the top or the sides of vehicles. In fact, the system 100 is not limited to ladder racks it may be mounted to roof racks, cargo racks, bike racks or the like. The size and shape of the system 100 and the mounting brackets 140 utilized (or not utilized) may be tailored to the rack that the system 100 will be installed to.

In fact, the system 100 is not limited to being used on vehicles at all. Rather, by using different mounting brackets 140 or no mounting brackets 140 at all the system 100 may be attached to any solid surface (e.g., wall, frame on any structure or vehicle). This provides advertizing opportunities where the advertisements may be easily changed in numerous locations.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments of the invention are intended to be protected broadly within the spirit and scope of the appended claims.

What is claimed:

1. A system comprising
a first tracking means to receive a first end of a sign therewithin;
a second tracking means to receive a second end of the sign therewithin;
a back plate coupled to the first tracking means and the second tracking means to support the first tracking means and the second tracking means and to space them a certain distance apart;
end plates to secure the one or more signs within the first tracking means and the second tracking means.

2. The system of claim 1, wherein a portion of the back plate extends past edges of the first tracking means and the second tracking means and the end plates are removeably connected to the portion.

3. The system of claim 2, wherein the sign is removable.

4. The system of claim 1, further comprising mounting brackets connected to the back plate so mount the system.

5. The system of claim 4, wherein the mounting brackets are to mount the system to a ladder rack.

6. The system of claim 4, wherein the mounting brackets are to mount the system to a vehicle.

7. The system of claim 4, wherein the mounting brackets are to mount the system to a surface.

8. The system of claim 1, wherein each of the first tracking means and the second tracking means include a plurality of channels, wherein each channel is to receive a sign so that the system can secure a plurality of signs.

9. The system of claim 8, wherein an outer sign is visible as an advertisement.

10. The system of claim 9, wherein the signs are reversible.
